(19) United States
(12) Patent Application Publication
(10) Pub. No.: US 2009/0061320 A1
(43) Pub. Date: Mar. 5, 2009

(54) ALKALINE BATTERY COMPRISING A CATHODE, AN ANODE, A SEPERATOR AND AN ALKALINE ELECTROLYTE

(76) Inventors: Alexandre M. Miranda, Agua Limpa (BR); Fernanda Vieira, Agua Limpa (BR); Ueverson B. Lima, Agua Limpa (BR)

Correspondence Address: FULBRIGHT & JAWORSKI, LLP, 1301 MCKINNEY, SUITE 5100, HOUSTON, TX, 77010-3095, US

(21) Appl. No.: 12/119,725

(22) Filed: May 13, 2008

(30) Foreign Application Priority Data
Aug. 28, 2007 (BR) PI0703826-7

(51) Int. Cl. H01M 4/50; H01M 4/58

(52) U.S. Cl. 429/224; 429/231.8; 429/229

(57) ABSTRACT

An alkaline battery includes a cathode containing manganese dioxide and carbon particles, and an anode containing zinc. Performance of the manganese dioxide cell is improved by optimizing the ratio of manganese dioxide to the composition of carbon particles in the cathode. The discharge capacity of the battery is increased as a result of using the expanded graphite which allows for a greater capacity of manganese dioxide to be incorporated into the cathode.

### CROSS-REFERENCE TO RELATED APPLICATIONS

This application claims priority, under 35 U.S.C. §119 to Brazilian Patent Application Number PI0703826-7 filed on Aug. 28, 2007.

### TECHNICAL FIELD

This invention relates to an alkaline battery including a manganese oxide and carbon cathode and an anode comprising zinc.

### BACKGROUND OF THE INVENTION

Alkaline batteries are employed as a source of energy. In general, alkaline batteries comprise a cathode, an anode, a separator and an electrolytic solution (electrolyte). The cathode usually includes particles of carbon to increase the conductivity, particles of manganese dioxide as active material and a binder. The anode can be composed of a gel containing particles of zinc as an active material. The electrolytic solution can consist of a hydroxide dispersed in the battery. The separator is located between the cathode and the anode.

One of the desired properties for an alkaline battery is to have a high discharge capacity. The amount of manganese dioxide incorporated into the cathode is one of the factors that limit this property. Usually, the relationship is proportional where increasing the amount of manganese dioxide incorporated into the cathode results in a larger discharge capacity. The cathode must also possesses a sufficient amount of carbon particles to grant the necessary conductivity. Therefore, a commitment solution exists between the amount of manganese dioxide that can be included in the cathode and the amount of carbon particles to achieve the appropriate conductivity.

Usually the particles of carbon used in the cathode are composed of graphite. Expanded graphite can be used in the cathode as a source of carbon particles. The expanded graphite is obtained through a process of chemical merging or electrochemistry of the natural graphite in the form of “flake”, followed by thermal shock at high temperatures, thus causing its exfoliation. This procedure increases the surface area of the graphite allowing greater contact with the particles of manganese dioxide. As a result, the expanded graphite particles provide a higher degree of conductivity to the cathode as the same amount of non-expanded graphite particles. Using the expanded graphite allows for a smaller amount of graphite and larger amount of manganese dioxide that can be housed in the cathode which increases the discharge capacity of the battery.

### BRIEF SUMMARY OF THE INVENTION

The present invention described herein relates to an alkaline battery having a cathode comprising manganese dioxide and particles of carbon, an anode comprising zinc, a separator, and an electrolyte (electrolytic solution). Performance of the manganese dioxide cell is improved by optimizing the ratio of manganese dioxide to the composition of carbon particles in the cathode. The discharge capacity of the battery is increased as a result of using the expanded graphite which allows for a greater capacity of manganese dioxide to be incorporated into the cathode

Certain embodiments of the invention concern compositions and methods for an alkaline battery, comprising a cathode, an anode, a separator, and an alkaline electrolyte wherein the cathode contains particles of carbon wherein said particles of carbon comprise 1% to 24% of expanded graphite, 76% to 99% of crystalline natural graphite.

In specific embodiments of this invention, the alkaline battery wherein said cathode comprises particles of carbon wherein said particles of carbon comprise from about 7% to about 14% by weight of particles of expanded graphite, and from about 86% to about 93% by weight of particles of crystalline natural graphite.

In other embodiments of the invention, the cathode comprises particles of carbon at a percentage of the total weight selected from a group consisting of: (a) 1% to 20% by weight of particles of carbon; (b) 3% to 14% by weight of particles of carbon; and (c) 5% to 9% by weight of particles of carbon. In specific embodiments, the cathode comprises from 80% to about 99% by weight of manganese dioxide.

In specific embodiments of this invention, the anode of the alkaline battery comprises zinc as an active material.

In certain embodiments of the invention, the crystalline natural graphite comprises medium size particles ranging from 2 μm (micrometer) to about 30 μm (micrometer) in size. Another embodiment of the invention includes expanded graphite comprising medium size particles ranging from 5 μm (micrometer) to about 40 μm (micrometer) in size.

Another embodiment of the present invention is a cathode for use in an alkaline battery, wherein said cathode comprises particles of carbon wherein said particles of carbon include between 1% and 24% of expanded graphite and between 76% and 99% of crystalline natural graphite and manganese dioxide.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### DETAILED DESCRIPTION OF THE INVENTION

As used herein the specification, “a” or “an” may mean one or more. As used herein in the claim(s), when used in conjunction with the word “comprising”, the words “a” or “an” may mean one or more than one. As used herein “another” may mean at least a second or more. Still further, the terms “having”, “including”, “containing” and “comprising” are interchangeable and one of skill in the art is cognizant that these terms are open ended terms. Some embodiments of the invention may consist of or consist essentially of one or more elements, method steps, and/or methods of the invention. It is contemplated that any method or composition described herein can be implemented with respect to any other method or composition described herein.

The present invention is related to an alkaline battery comprising a cathode, an anode, a separator and an alkaline electrolyte, wherein said cathode accommodating particles of carbon comprising from about 1% to about 24% by weight of particles of expanded graphite and from about 76% to about 99% by weight of particles of crystalline natural graphite.

Preferably, the mixture comprises from about 7% to about 14% by weight of particles of expanded graphite and from about 86% to about 93% by weight of particles of crystalline natural graphite. The mixture allows the increment of the conductivity of the cathode, being still more lubricant and therefore easier to process than the isolated graphite particles.

Advantageously, the alkaline battery presents cathode comprising from about 1% to about 20% by weight of particles of carbon. More advantageously, the alkaline battery presents cathode comprising from about 3% to about 14% by weight of particles of carbon. Still more advantageously the alkaline battery presents cathode comprising from about 5% to about 9% by weight of particles of carbon.

The invention also refers to a cathode accommodating a mixture of particles of crystalline natural graphite and particles of expanded graphite. Advantageously, the cathode comprises manganese dioxide. Preferably, the cathode comprises particles of carbon including between 1% and 24% of expanded graphite and between 76% and 99% of crystalline natural graphite and manganese dioxide.

Preferably, the alkaline battery presents a cathode comprising from about 80% to about 99% by weight of manganese dioxide and from about 1% to about 20% by weight of particles of carbon.

Preferably, the medium size of the particle of crystalline natural graphite ranges from about 2 to about 30 μm. More preferably, the medium size ranges from about 8 to about 20 μm. Advantageously the medium size of the particle of expanded graphite ranges from about 5 to about 40 μm. More advantageously the medium size ranges from about 8 to about 30 μm. Preferably, the alkaline battery presents an anode comprising zinc as an active material.

Advantageously the battery have a cathode comprising manganese dioxide and a mixture of particles of carbon supplying at least 95%, preferably 97%, more preferably 98%, of the performance in continuous discharge test of 1 watt (1 A, continuous, with cut-off in 0.9 V), pulse regime simulating digital camera (1.5 W/650 mW, 2 seg/30 seg, with cut-off in 0.9 V) and test simulating camera flash (1.2 A, 3 seg/10 seg, with cut-off in 0.9 V).

Other details of the invention will become apparent from the description of preferred embodiments and examples set forth below, that are merely illustrative and are not to be construed as limiting the present invention, as well as from the accompanying claims.

In one embodiment, 30 grams of each mixture are prepared (crystalline natural graphite+expanded graphite) in a shake mechanism, generating four samples presenting the two graphite forms: one sample presenting only crystalline natural graphite (therefore without presenting expanded graphite) and one sample comprising only expanded graphite.

Discharge tests were conducted in alkaline cells. Such tests were chosen in function of the duration and of the performance demanded. Therefore there were conducted 03 tests: one of continuous discharge and the remaining two of pulses in the following way:
1. 1 A, continuous, with cut-off in 0.9 V (continuous discharge)
2. 1.5 W/650 mW, 2 sec/30 sec, with cut-off in 0.9 V (simulating a digital camera)
3. 1.2 A, 3 sec/10 sec, with cut-off in 0.9 V (simulating a camera flash

TABLE 1
TEST RESULTS.

| | | | 1.5 W/650 mW |
|---|---|---|---|
| | 1 A continuous | 1.2 A 3 s/10 s | 2 s/30 s |
| Sample | (Ah) | (Cycles) | (Ah) |
| 100% of crystalline | 0.92 | 804 | 0.34 |
| natural graphite | | | |
| in the sample | | | |
| 1% of expanded | 0.96 | 823 | 0.36 |
| graphite in the sample | | | |
| 5% of expanded | 0.94 | 794 | 0.35 |
| graphite in the sample | | | |
| 10% of expanded | 1.00 | 901 | 0.44 |
| graphite in the sample | | | |

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An alkaline battery, comprising:
a cathode,
an anode;
a separator, and;
an alkaline electrolyte;
wherein said cathode contains particles of carbon
wherein said particles of carbon comprise:
1% to 24% of expanded graphite, and
76% to 99% of crystalline natural graphite.

2. The alkaline battery of claim 1, wherein said particles of carbon comprise from about 7% to about 14% by weight of particles of expanded graphite, and from about 86% to about 93% by weight of particles of crystalline natural graphite.

3. The alkaline battery of claim 1, wherein the cathode comprises particles of carbon at a percentage of the total weight selected from a group consisting of:
a. 1% to 20% by weight of particles of carbon;
b. 3% to 14% by weight of particles of carbon; and,
c. 5% to 9% by weight of particles of carbon.

4. The alkaline battery of claim 3, wherein the cathode further comprises from 80% to about 99% by weight of manganese dioxide.

5. The alkaline battery of claim 1, wherein the anode comprises zinc as an active material.

6. The alkaline battery of claim 1, wherein the crystalline natural graphite comprises medium size particles ranging from 2 μm (micrometer) to about 30 μm (micrometer) in size.

7. The alkaline battery of claim 1, wherein the expanded graphite comprises medium size particles ranging from 5 μm (micrometer) to about 40 μm (micrometer) in size.

8. A cathode for a battery, wherein said cathode comprises particles of carbon wherein said particles of carbon include between 1% and 24% of expanded graphite and between 76% and 99% of crystalline natural graphite and manganese dioxide
